(19) United States
(12) Patent Application Publication
(10) Pub. No.: US 2026/0084389 A1
(43) Pub. Date: Mar. 26, 2026

(54) METHOD FOR MANUFACTURING, ON A CORE, A PNEUMATIC TIRE WITH A CARCASS COMPRISING REINFORCEMENTS WHICH ARE INCLINED IN THE SIDEWALLS AND ARE RADIAL UNDER THE CROWN

(71) Applicant: Compagnie Generale Des Etablissements Michelin, Clermont-Ferrand (FR)

(72) Inventors: Tony DEVAUX, Clermont-Ferrand (FR); Jean-Michel BELLARD, Clermont-Ferrand (FR); Christophe CHOUZENOUX, Clermont-Ferrand (FR); Aurelien FABRE, Clermont-Ferrand (FR); Jerome FRECON, Clermont-Ferrand (FR)

(21) Appl. No.: 19/109,710

(22) PCT Filed: Oct. 25, 2022
(86) PCT No.: PCT/EP2023/075237

§ 371 Date: Mar. 7, 2025

(30) Foreign Application Priority Data
Sep. 20, 2022 (FR) FR2209490

(51) Int. Cl. B29D 30/16

(52) U.S. Cl. CPC B29D 30/1635; B29D 2030/1678

(57) ABSTRACT

The method includes laying a set of carcass reinforcers on a core. The carcass reinforcers each follow a laying trajectory which is contained in a laying plane that is parallel to the central axis of the core and at a distance from the central core. As such, each carcass reinforcer follows, in the crown zone of the core, a radial plane containing the central axis. The carcass reinforcers therefore extend parallel to the central axis in the crown of the tire, while, in orthogonal projection in a reference plane normal to the central axis, this same carcass reinforcer forms, in the lateral zones of the core and therefore in the sidewalls of the tire, a non-zero inclination angle with respect to the radial plane containing the central axis.

### CROSS-REFERENCE TO RELATED APPLICATION

The subject application claims priority to PCT Application No. PCT/EP2023/075237, filed 14 Sep. 2023, and entitled “METHOD FOR MANUFACTURING, ON A CORE, A PNEUMATIC TYRE WITH A CARCASS COMPRISING REINFORCEMENTS WHICH ARE INCLINED IN THE SIDEWALLS AND ARE RADIAL UNDER THE CROWN,” and to French Patent Application No. FR2209490, filed 14 Sep. 2022, and entitled “METHOD FOR MANUFACTURING, ON A CORE, A PNEUMATIC TYRE WITH A CARCASS COMPRISING REINFORCEMENTS WHICH ARE INCLINED IN THE SIDEWALLS AND ARE RADIAL UNDER THE CROWN,” the entire contents of which are both herein incorporated by reference.

### BACKGROUND

### 1. Field

The present disclosure lies in the field of methods and installations intended for manufacturing pneumatic tires.

### 2. Related Art

An installation for creating a reinforcing structure for the tire by laying reinforcer threads on a toroidal core, the shape of which corresponds to that of the tire to be manufactured, is known from document WO-2006/051082.

This installation advantageously makes it possible, by means of a rocker arm which rocks in an alternating movement about the surface of the core, to lay either reinforcers which are inclined along an oblique direction with respect to the circumferential direction of the tire, making it possible to form a reinforcement of the “bias ply carcass” type, or reinforcers which are contained in radial planes, perpendicular to the circumferential direction of the tire, making it possible form a reinforcement of the “radial ply carcass”type.

In a manner known per se, each of these two types of reinforcements has advantages that are inherent thereto. In particular, the radial reinforcement affords excellent road holding, while the bias reinforcement confers stiffness and increased robustness on the sidewalls of the tire.

Of course, there is a permanent desire to improve the quality, the dynamic performance and the service life of tires, in particular for demanding applications such as motor racing.

### SUMMARY

For this reason, the objectives of the present disclosure aim to provide a new method for manufacturing tires which, while remaining effective and easy to implement industrially, makes it possible to produce tires, the reinforcement of which exhibits enhanced performance aspects, and more particularly tires which combine a road holding quality similar to or better than that afforded by the radial reinforcements with a sidewall stiffness similar to or better than that afforded by the bias reinforcements.

These objectives have been achieved by means of a method for manufacturing a tire, comprising a preparation step (a) during which a core is prepared which has a toroidal receiving surface which is centered on a central axis and which comprises a crown zone intended to receive components of the crown of the tire, and, axially on either side of said crown zone, a first lateral zone intended to receive components of a first sidewall and of a first bead of the tire, and a second lateral zone intended to receive components of a second sidewall and of a second bead of the tire. Then, the method includes a step (b) of laying carcass reinforcers, during which a plurality of reinforcers, referred to as “carcass reinforcers”, which each extend from a starting position, situated in one of the first and second lateral zones, to an end position, situated in the other of the first and second lateral zones, passing through the crown zone, are laid on the receiving surface of the core, by means of a laying head. During the step (b) of laying carcass reinforcers, the laying head is configured with respect to the core so as to describe, each time a carcass reinforcer is laid, a trajectory referred to as the “laying trajectory” which connects the starting position of the carcass reinforcer in question to the end position of the reinforcer in question and which is contained in a plane referred to as the “laying plane” which is parallel to the central axis and at a distance from the central axis such that the laying trajectory follows, next to the crown zone of the core, a radial plane containing the central axis while, in orthogonal projection in a reference plane normal to the central axis, this same laying trajectory, and more generally the laying plane, form, in the first and second lateral zones of the core, a non-zero inclination angle with respect to said radial plane containing the central axis.

Advantageously, the method according to the present disclosure, by virtue of the fact that it uses a laying plane referred to as “offset”, in that said laying plane is parallel to the central axis of the core but does not contain said central axis of the core, makes it possible to create carcass reinforcers that are inclined in the sidewalls, that is to say are not radial, and which are therefore not perpendicular to the circumferential direction of the tire in the sidewalls of the tire, as is the case within bias ply carcasses, but which, on the other hand, are radial in the crown of the tire, and therefore perpendicular to the circumferential direction of the tire in the crown, as is the case within radial ply carcasses.

Particularly advantageously, it is possible, as will be described in detail below, to repeat the laying step by modifying the inclination angle of the laying plane, so as to lay a first set of carcass reinforcers at a first laying angle and then to lay, on top of said first set of carcass reinforcers, a second set of reinforcers at a second laying angle of opposite sign to the first laying angle, such that the carcass reinforcers of the second set are interlaced with the carcass reinforcers of the first set in the lateral zones of the core, while the carcass reinforcers of the second set extend parallel to the carcass reinforcers of the first set, on radial planes, in the crown zone. In this way, a carcass, and more generally a tire, is obtained which has carcass reinforcers that intersect in its sidewalls, and consequently enhanced stiffness of the sidewalls, as in a conventional bias reinforcement, while keeping radial carcass reinforcers under its crown, as in a conventional radial reinforcement.

The method according to the present disclosure makes it possible to obtain tires within which the carcass reinforcers bring about, at the shoulders of the tire which form the transition between the sidewalls and the crown of said tire, a gradual change in their orientation angle with respect to the circumferential direction of the tire, when the reinforcers pass from an orientation which, in the sidewalls, is inclined and therefore not perpendicular to the circumferential direction, to an orientation which, in the crown, is perpendicular to the circumferential direction. However, it turns out that the gradual nature of this change in orientation of the carcass reinforcers confers on the tire increased resistance to decohesion, at the shoulders of the tire, in the zone which is situated between the carcass reinforcers of the sidewall, on one side, and, on the other side, the selvedges of the crown plies which cover the carcass ply in the crown of the tire, and therefore the reinforcers intersect one another and the radial reinforcers of the carcass ply that are present in the crown so as to form, in a manner known per se, a reinforcement with triangular meshes. The present disclosure therefore makes it possible to reinforce the tire and increase its service life.

In this respect, the fact that the laying operations are carried out on a core, the toroidal shape of which corresponds to the final shape of the tire, makes it possible to retain, in the finished and vulcanized tire, the orientation angles of the carcass reinforcers, and therefore the transition between these orientation angles at the shoulders, such that these orientation angles and this transition of orientation angles are initially defined in the green tire by the laying head, during the step (b) of laying the carcass reinforcers. The lack of alteration of the initial disposition of the carcass reinforcers advantageously makes it possible to control the qualities of the tire in a perfectly reproducible manner.

### BRIEF DESCRIPTION OF THE DRAWINGS

Further objectives, features and advantages of the present disclosure will become apparent in more detail on reading the following description and with the aid of the appended drawings, which are provided purely by way of non-limiting illustration, and in which:

FIG. 1 illustrates, in a schematic side view, in projection in a reference plane normal to the central axis, an arrangement principle of carcass reinforcers according to the disclosure, in accordance with a first inclination angle. This figure reveals in particular the way in which this inclination angle can be obtained by creating a distance between the laying plane and the central axis, either by tilting the laying plane or by offsetting said laying plane in translation along a direction orthogonal to the central axis.

FIG. 2 illustrates, in a schematic developed view which reveals, in one and the same flattening plane, a portion of the crown zone and the corresponding portions of the first and second lateral zones which border said crown zone respectively on each side of said crown zone, an arrangement principle according to the disclosure, in which a first set of carcass reinforcers, depicted by solid lines, are laid at a first inclination angle and a second set of carcass reinforcers, depicted by broken lines, are laid at a second inclination angle of opposite sign to the first inclination angle. Thus, the reinforcers of the second set are interlaced with those of the first set in the lateral zones, and therefore, ultimately, in the sidewalls of the tire, while the reinforcers of the first and of the second set all extend parallel to one another, and parallel to the central axis, in the crown zone, and therefore, ultimately, in the crown of the tire. The carcass reinforcers of the first set and those of the second set are thus perpendicular to the circumferential direction of the tire in the crown zone, and not perpendicular to said circumferential direction in the lateral zones.

FIG. 3 illustrates, in a view in section in a radial plane containing the central axis, a tire obtained by a method according to the disclosure.

FIG. 4 illustrates, in a side view in projection in a plane normal to the central axis, a tire manufacturing installation according to the disclosure, the laying head of which has been placed in a first configuration so as to lay on the core a first set of carcass reinforcers, at a first inclination angle. To make the figure easier to read, the increment pitch between successive carcass reinforcers has been artificially increased compared with the actual increment pitch.

FIG. 5 is an enlarged view of a detail ringed in FIG. 4.

FIG. 6 is a perspective overall view of the installation in FIG. 4.

FIG. 7 illustrates, in a side view in the same projection plane as FIG. 4, the installation in FIGS. 4 to 6, the laying head of which has been placed in a second configuration so as to lay on the core, on top of the first set of carcass reinforcers, a second set of carcass reinforcers at a second inclination angle. Here again, to make the figure easier to read, the increment pitch between successive carcass reinforcers has been artificially increased compared with the actual increment pitch.

### DETAILED DESCRIPTION OF THE ENABLING EMBODIMENT

The present disclosure relates to a method for manufacturing a tire 1, and to a corresponding installation 100.

The tire 1, which is preferably a pneumatic tire, is intended to be fitted on a vehicle wheel.

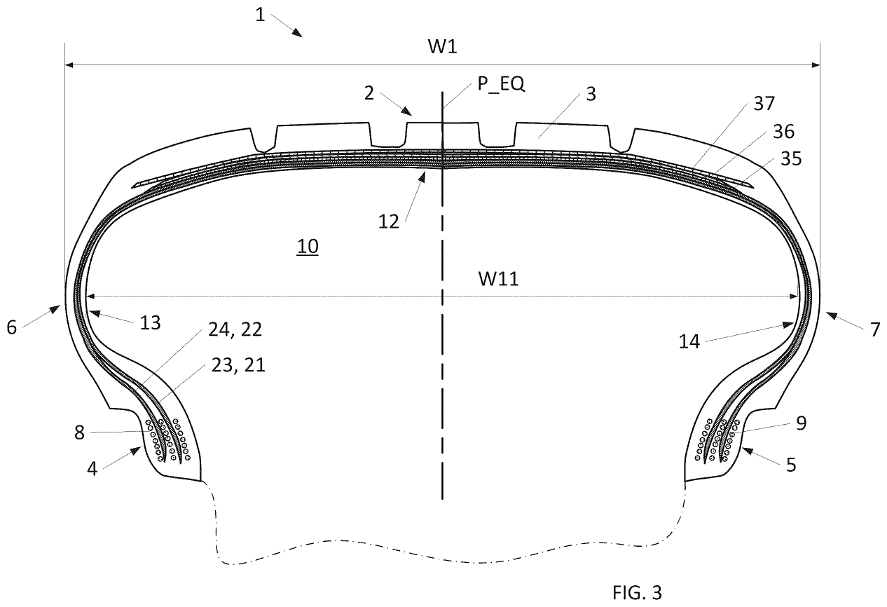

In a manner known per se, and as can be seen in FIG. 3, the tire 1 comprises a crown 2 which has a tread 3 intended to come into contact with the ground when running, a first bead 4 and a second bead 5 for securing the tire to a mounting support such as a rim, and a first sidewall 6 which connects the crown 2 to the first bead 4 and a second sidewall 7 which connects the crown 2 to the second bead 5.

In a manner known per se, the first bead 4 will contain a first bead wire 8 and the second bead 5 will contain a second bead wire 9. Each of these bead wires 8, 9 forms an annular band, which is substantially inextensible along the circumferential direction of the tire 1, such that each bead wire reinforces the bead 4, 5 in which it is located and therefore ensures the solidity of the securing of the tire 1 to the rim.

The method according to the disclosure first of all comprises a preparation step (a) during which a core 10 which has a toroidal receiving surface 11 is prepared. Said receiving surface 11 is centred on a central axis X10 of the core 10 and comprises, as can be seen in particular in FIG. 3, a crown zone 12 intended to receive components of the crown 2 of the tire, including the tread 3, and, axially on either side of said crown zone 12, a first lateral zone 13 which is intended receive components of a first sidewall 6 and of a first bead 4 of the tire 1, and a second lateral zone 14 which is intended to receive components of a second sidewall 7 and of a second bead 5 of the tire 1.

The core 10 is preferably metallic.

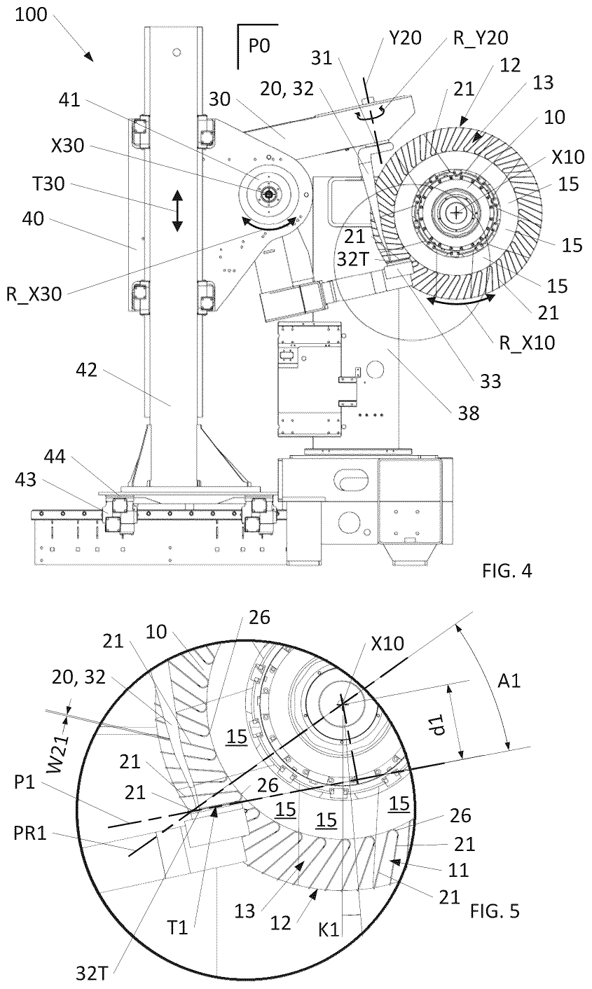

As can be seen in FIGS. 4, 5, 6 and 7, said core 10 is also preferably subdivided, about the central axis X10, into a plurality of sectors 15 which are separable from one another in order to allow the core 10 to be removed and to allow the core 10 to be extracted from the tire 1 after the tire 1 has been built and then vulcanized on said core 10.

In practice, the central axis X10 of the core 10 corresponds to the central axis of the tire 1, about which the tire 1 substantially has a toroidal shape exhibiting symmetry of revolution, and about which the tire 1 will rotate when running, once mounted on the wheel of the vehicle.

By convention and for convenience of description:
“axial” means a direction which is parallel to the axis in question, in this case more particularly a direction parallel to the central axis X10;
“radial” means a direction which is perpendicular to the axis in question, that is to say which intersects the axis in question and forms a right angle with said axis in question; in this case more particularly a direction perpendicular to the central axis X10;
“circumferential” means a direction which, at the point in question, is contained in a plane normal to the axis in question, in this case more particularly a plane normal to the central axis X10, and is perpendicular to the radius which connects said axis in question to the point in question; that is to say a direction which is normal to the radial plane passing through the point in question, or, equivalently, a so-called “orthoradial” direction which is orthogonal to the axis in question and perpendicular to the radial direction at the point in question.

Preferably, if the tire 1 is a pneumatic tire, a layer of sealing rubber, based for example on butyl rubber, will first of all be laid on the core 10, in order to ensure the airtightness of the inflation chamber of the pneumatic tire.

The method according to the disclosure then comprises, after the preparation step (a), and, if it takes place, after the layer of sealing rubber has been laid, a step (b) of laying carcass reinforcers, during which a plurality of reinforcers 21, 22, referred to as “carcass reinforcers” 21, 22, which each extend from a starting position 21A, 22A, situated in one of the first and second lateral zones 13, 14, to an end position 21B, 22B, situated in the other of the first and second lateral zones 14, 13, passing through the crown zone 12, are laid on the receiving surface 11 of the core 10, by means of a laying head 20.

Preferably, the starting position 21A, 22A of each carcass reinforcer 21, 22 is situated in a portion of the lateral zone 13, 14 in question which is intended to receive the components of the corresponding bead 4, 5, while the end position 21B, 22B of said carcass reinforcer 21, 22 is situated in a portion of the other lateral zone 14, 13 which is intended to receive the components of the other bead 5, 4.

More particularly, the starting position 21A, 22A of each carcass reinforcer 21, 22, or, respectively, the end position 21B, 22B of each carcass reinforcer 21, 22, is situated in a radial area which will be covered by the bead wire 8, 9 with which the lateral zone 13, 14 in question is equipped.

Thus, each carcass reinforcer 21, 22 extends continuously so as to connect the first bead 4 to the opposite second bead 5, and more particularly to connect the first bead wire 8 to the second bead wire 9 axially opposite the first bead wire 8.

Preferably, each bead wire 8, 9 is obtained by creating, on the core, at the location of the corresponding bead 4, 5, and as can be seen in FIG. 3, a multi-turn winding, that is to say extending through multiple complete revolutions about the central axis X10, of a filamentary reinforcing element containing one or more, preferably metallic, reinforcing threads which extend continuously in the lengthwise direction of said filamentary reinforcing element.

Preferably, each carcass reinforcer 21, 22 is formed by a thread, or more preferably by a set of a plurality of threads that are interwoven to form a cord, said thread, or said threads, being made from a textile material.

The use of a textile material advantageously makes the carcass reinforcer 21, 22 very lightweight and also gives it a certain flexibility, which allows said carcass reinforcer 21, 22 to create a smooth transition between the crown zone 12 and each of the first and second lateral zones 13, 14, at the shoulder of the tire 1.

Said textile material may be either a synthetic polymer material such as polyethylene terephthalate (PET) or polyamide (for example Nylon®), or a natural textile fibre.

Alternatively, at least some of the carcass reinforcers 21, 22, or even all of the carcass reinforcers 21, 22, could be made from a metallic material, preferably in the form of an integral thread.

According to further conceivable variants, at least some of the carcass reinforcers 21, 22, or even all of the carcass reinforcers 21, 22, could each be formed by:
a strip, preferably of rectangular cross section, said strip combining a plurality of textile or metallic reinforcing threads, which are distributed parallel to one another across the width of the strip, which extend along the entire length of said strip, and which are embedded in a rubber-based matrix, or
a composite band comprising glass fibres embedded in a resin matrix.

In any event, regardless of the nature of the carcass reinforcer 21, 22 in question, said carcass reinforcer 21, 22 will be a so-called “filamentary” element, that is to say an element of which the length, considered from its starting position 21A, 22A to its end position 21B, 22B, is at least 10 times, preferably at least 50 times, or even preferably at least 100 times, greater than the greatest transverse dimension of said element, referred to as “width” W21, W22, considered perpendicularly to the length, that is to say at least 50 times, preferably at least 100 times greater than the greatest dimension of the cross section of said carcass reinforcer.

Preferably, a layer of encapsulating rubber is also laid on the core 10 in order to embed the carcass reinforcers 21, 22 in said layer of encapsulating rubber, so as to form one or, where appropriate, a plurality of corresponding carcass plies 23, 24, each carcass ply 23, 24 thus comprising a layer of encapsulating rubber reinforced by carcass reinforcers 21, 22 which extend parallel to one another within said layer of encapsulating rubber. The layer of encapsulating rubber is laid on the core 10 before the carcass reinforcers 21, 22, and, where appropriate, after the layer of sealing rubber, such that said layer of encapsulating rubber makes it possible to retain the carcass reinforcers 21, 22 on the core 10, by an adhesion effect, while they are being laid.

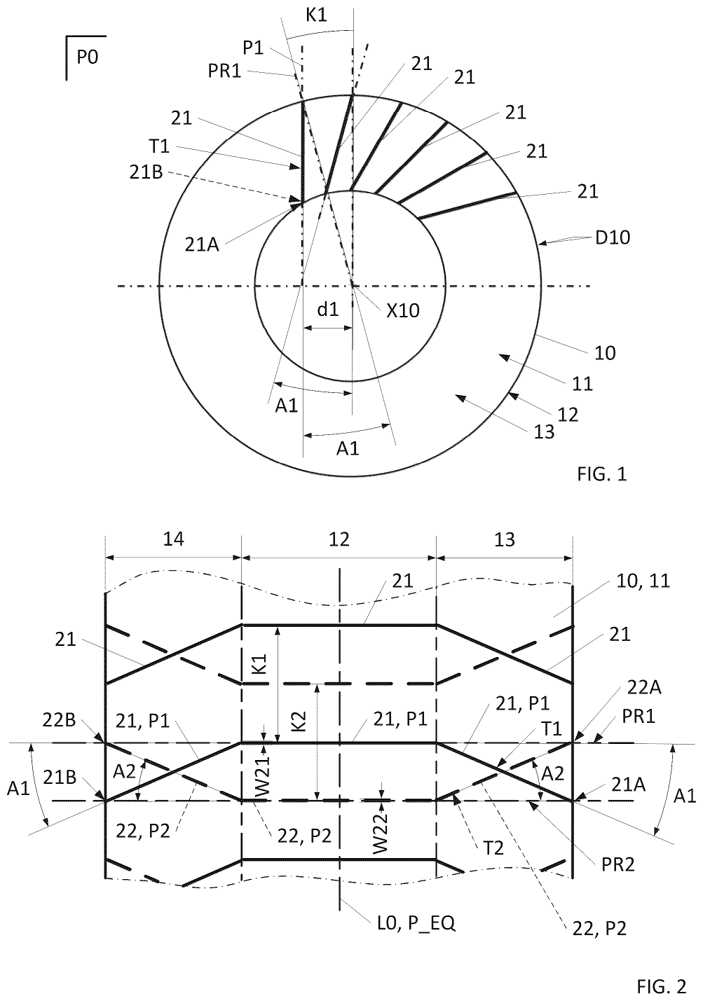

According to the present disclosure, during the step (b) of laying carcass reinforcers, the laying head 20 is configured with respect to the core 10 so as to describe, each time a carcass reinforcer 21, 22 is laid, a trajectory referred to as the “laying trajectory” T1, T2 which connects the starting position 21A, 22A of the carcass reinforcer in question to the end position 21B, 22B of the reinforcer in question and which is contained in a plane referred to as the “laying plane” P1, P2 which is parallel to the central axis X10 and at a distance from the central axis X10 such that the laying trajectory T1, T2 follows, next to the crown zone 12 of the core 10, a radial plane PR1, PR2 containing the central axis X10 while, in orthogonal projection in a reference plane P0 normal to the central axis X10, this same laying trajectory T1, T2, and more generally the laying plane P1, P2, form, in the first and second lateral zones 13, 14 of the core, a non-zero inclination angle A1, A2 with respect to said radial plane PR1, PR2 containing the central axis X10, as can be seen in particular in FIGS. 1 and 2.

Advantageously, the laying plane P1, P2 on which the carcass reinforcer 21, 22 axially crosses the crown is parallel to the central axis X10 of the core, such that the carcass reinforcer 21, 22 runs parallel to said central axis X10 in the crown zone 12 of the core 10, but said laying plane P1, P2, on the other hand, does not contain said central axis X10, by virtue of the non-zero offset distance d1, d2 which separates said central axis X10 from said laying plane P1, P2, and which confers an inclination on said laying plane P1, P2 with respect to the radial plane PR1, PR2.

The radial plane PR1, PR2, by definition, contains the central axis X10 and, by convention, passes through the point of the laying trajectory T1, T2 which is radially outermost, that is to say which is radially farthest away from said central axis X10 (and which is therefore situated in the crown zone 12 of the core 10).

Thus, the laying plane P1, P2 and said radial plane PR1, PR2 according to the present disclosure are therefore not parallel to one another, and consequently intersect one another.

In practice, the laying trajectory T1, T2, and therefore the path of the carcass reinforcer 21, 22 in the crown zone 12 of the core, corresponds to the straight line formed by the intersection of the laying plane P1, P2 and the corresponding radial plane PR1, PR2.

Since the laying plane P1, P2 is parallel to the central axis X10 of the core 10, the portion of the laying trajectory T1, T2 followed by a carcass reinforcer 21, 22 in the first lateral zone 13 is superposed, in projection in the reference plane P0, on the portion of the laying trajectory T1, T2 followed by this same carcass reinforcer 21, 22 in the second lateral zone 14.

Similarly, the starting position 21A, 22A and the end position 21B, 22B of a single carcass reinforcer are thus both located at the same azimuth about the central axis X10.

By virtue of the present disclosure, and as is clearly visible in FIG. 2, the laying plane P1, P2, and consequently the laying trajectory T1, T2 along which the carcass reinforcer 21, 22 runs over the receiving surface 11 of the core 10, forms with the circumferential direction L10 of the core 10 (the angle being measured starting from the circumferential direction and ending on the laying trajectory T1, T2), and therefore forms with the circumferential direction of the tire 1, a right angle (i.e. 90 degrees) in the crown zone 12, and a non-right angle, complementary to the inclination angle A1, A2, in each of the first and second lateral zones 13, 14 (meaning that, in said lateral zones 13, 14, the sum of the absolute value of the inclination angle A1, A2 and of the absolute value of the angle formed by the laying plane P1, P2 with respect to the circumferential direction is 90 degrees).

By way of indication, in the crown zone 12, the carcass reinforcer 21, 22 extends in the radial plane PR1, PR2, along a straight segment parallel to the central axis X10, over a distance which represents at least 30%, preferably at least 50%, or even at least 70%, and even sometimes 90% or more, of the overall axial width W11 of the receiving surface 11 of the core 10, and/or over a distance which represents at least 30%, preferably at least 50%, or even at least 70%, and even sometimes 90% or more, of the overall axial width W1 of the tire 1 (i.e. the distance axially separating the axially outermost points of the first and second sidewalls 6, 7 of said tire 1, as can be seen in FIG. 3).

It will be noted that, for convenience of description, the width W21, W22 of the carcass reinforcer 21, 22 can be ignored in light of the overall diameter of the core 10, and therefore this filamentary carcass reinforcer 21, 22 can be likened to a line contained in the laying plane 21, 22.

Specifically, by way of indication, the width W21, W22 of the carcass reinforcer is preferably less than or equal to 2 mm, and, for example, between 0.40 mm and 1.00 mm, for example between 0.56 mm and 0.97 mm. This width W21, W22 may correspond to the diameter of the circular section in which the reinforcer is inscribed if it is made up of a single thread or of a cord.

Preferably, the width W21, W22 of the carcass reinforcer, in relation to the overall circumference of the core 10, i.e. to the circumference of the circle of greatest diameter D10 formed by the orthogonal projection of said core in the reference plane P0, typically a diameter of between 610 mm and 850 mm for tires intended for passenger vehicles, represents an arc which corresponds to an angular sector which covers less than 0.5 degrees, or even less than 0.2 degrees, about the central axis X10.

Be that as it may, if, strictly speaking, the width W21, W22 of the carcass reinforcer 21, 22 were considered to be non-negligible, the principle of the present disclosure could be applied by considering that the trajectory referred to as “volume trajectory”, i.e. the set of points in space that the carcass reinforcer 21, 22 describes when the cross section of said carcass reinforcer 21, 22 sweeps along the curve formed by the laying trajectory T1,T2, lies between two planes referred to as “gauge planes” which are parallel to the laying plane P1, P2 (thus referred to as a “theoretical” laying plane) containing the laying trajectory T1, T2 and which are each at a tangent to one of the selvedges of the carcass reinforcer 21, 22, such that said gauge planes are parallel to one another, at a distance from one another by the value of the width W21, W22 of the carcass reinforcer in question, and are both parallel to the central axis X10, and also by considering that the central axis X10 of the core is situated outside the volume of the space which is included between these two gauge planes.

In other words, it is ensured that none of the planes parallel to the theoretical laying plane P1, P2 and passing through any of the material points of the carcass reinforcer 21, 22 in question contains the central axis X10 of the core and also that that one of the two gauge planes that passes closest to said central axis X10 of the core remains located at a non-zero distance from central axis X10 of the core, typically equal to the abovementioned offset value d1, d2, so as to form the desired inclination angle A1, A2 with the corresponding radial plane PR1, PR2.

Thus, all the planes parallel to the theoretical laying plane P1, P2 and passing through any one of the material points of the carcass reinforcer 21, 22 in question. That is to say all the planes which are parallel to the gauge planes and included between the gauge planes, will be inclined in the lateral zones 13, 14, at an inclination angle A1, A2 which is of the same sign and the same value for each of the planes.

According to one particularly preferred embodiment variant, the core 10 is mounted so as to be able to rotate R_X10 about its central axis X10, and the laying head 20, in order to be able to execute the laying trajectory T1, T2, is mounted so as to be able to tilt about an axis Y20 referred to as the “roll axis”Y20 which is orthogonal to the central axis X10.

In this regard, the laying head 20 may preferably be articulated on a laying body 30 by means of a roll pivot link 31 which embodies the roll axis Y20.

The roll axis Y20 is normal to the chosen laying plane P1, P2.

This ensures that the laying head 20, trapped by the roll pivot connection 31, clearly describes a laying trajectory T1, T2 contained in the chosen laying plane P1, P2, and that the carcass reinforcer 21, 22 will thus form a bow contained in the laying plane P1, P2.

As is illustrated in FIGS. 4, 5, 6 and 7, the laying head 20 may be in the form of a thread-guiding rocker arm 32, which in this case is substantially L-shaped, said rocker arm 32 being connected to the laying body 30 by means of the roll pivot connection 31 and having a tip 32T which thus describes, when said thread-guiding rocker arm 32 carries out its tilting movement R_Y20 by pivoting about the roll axis Y20, the chosen laying trajectory T1, T2 next to the receiving surface 11 of the core 10.

The carcass reinforcer 21, 22, and more particularly the thread or the cable that makes up said carcass reinforcer 21, 22, is paid out during the tilting movement of the rocker arm 32, and is progressively pressed by the tip 32T of said rocker arm 32 against the receiving surface 11, in this case more particularly against the layer of rubber previously laid on said receiving surface 11, thereby tracing the route of the laying trajectory T1, T2 contained in the chosen laying plane P1, P2.

The laying body 30 may also have a pressing member 33 which is intended to temporarily keep the portion of the carcass reinforcer 21, 22 that is situated in the starting position 21A, 22A pressed against the core 10, while the laying head 20 carries out the tilting laying movement R_Y20.

Such a pressing member 33 may in particular comprise a hammer and hook system as described in application WO-2006/051082 already mentioned above.

Advantageously, by providing a core 10 that rotates about its central axis X10 and a laying head 20 mounted so as to be able to tilt about the roll axis Y20, it is possible, each time a new carcass reinforcer 21, 22 is laid, to carry out a sequence referred to as an “elementary sequence.” The elementary sequence includes a positioning phase during which the laying head 20 is positioned next to the starting position 21A, 22A of the carcass reinforcer 21, 22 to be laid, in a predefined angular sector of the core 10 about the central axis X10. In this case, therefore, more particularly, the tip 32T of the rocker arm 32 is positioned next to the portion of the lateral zone 13, 14 corresponding to the bead 4, 5 and situated on the side of the core 10 at which the laying of the carcass reinforcer 21, 22 is intended to be started. Then the elementary sequence includes a laying phase during which the roll tilting R_Y20 of the laying head 20 about the roll axis Y20 is brought about, while the core 10 is rotationally fixed about its central axis X10, so as to lay the carcass reinforcer 21, 22 in the angular sector in question along the laying trajectory T1, T2 contained in the chosen laying plane P1, P2, parallel to the central axis X10 and at a distance from said central axis X10. The elementary sequence then includes an incrementing phase, during which the rotation R X10 of the core 10 is triggered so as to increment the angular position of the core 10 about its central axis X10 by an increment value which is defined on the basis of, and preferably so as to be equal to, a chosen repeat pitch K1, K2 with which the carcass reinforcers 21, 22 are intended to be distributed about the central axis X10. Then the core 10 is immobilized in the angular position, such that the core 10 has, next to the laying head 20, a new angular sector in which it is possible to lay, in a next elementary sequence, another carcass reinforcer 21, 22 while retaining the chosen laying plane P1, P2.

Advantageously, such a solution makes it possible to retain, in a simple and reliable manner, on passing from the laying of one carcass reinforcer 21, 22 to the laying of the next carcass reinforcer 21, 22, a fixed configuration for adjusting the laying head 20 which defines the laying plane P1, P2 with respect to the fixed frame of reference of the central axis X10 of the core. Thus, from one carcass reinforcer 21, 22 to the next carcass reinforcer 21, 22, the laying plane P1, P2, and more particularly the orientation of said laying plane P1, P2 as defined by its inclination angle A1, A2, is retained without it being necessary to modify the setting of the roll axis Y20 or, more generally, the setting of the configuration of the laying head 20.

Preferably, the laying head 20, in this case the rocker arm 32, is designed to be set in alternating movement about the roll axis Y20, so as to be able to lay one carcass reinforcer 21, 22 during its outward movement, in a first direction of rotation about the roll axis Y20, and then the next carcass reinforcer 21, 22 during its return movement, in an opposite second direction of rotation about the roll axis Y20, and so on.

Thus, provision will advantageously be made of two pressing members 33, one on each side of the core 10, next to the location of each bead 4, 5.

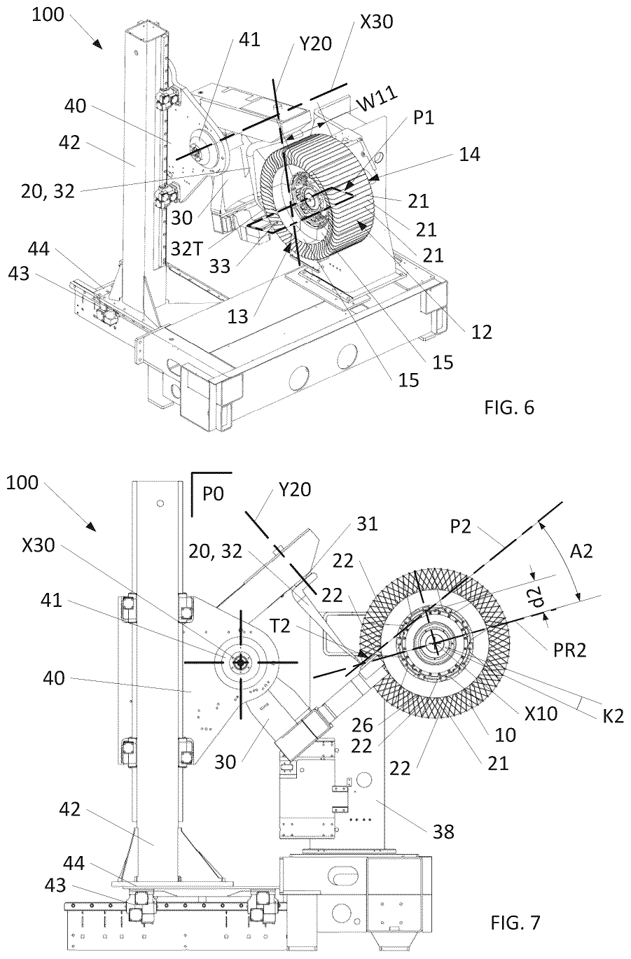

Preferably, as can be seen in particular in FIGS. 5 and 6, the successive carcass reinforcers 21, 22 which are laid on the core 10 on one and the same laying plane P1, P2, and therefore at one and the same inclination angle A1, A2, form one and the same integral thread, which is continuously unwound from a supply coil (not shown) and which is laid boustrophedonically by the alternate tilting movements R_Y20 of the laying head 20, without interruption of the thread between one carcass reinforcer 21, 22 and the next carcass reinforcer 21, 22.

The bows formed by the successive carcass reinforcers 21, 22, which each span the crown zone 12, are thus connected by turn-back loops 26, which run in the zones of the beads 4, 5, each from the end position 21B, 22B of one carcass reinforcer 21, 22 to the starting position 21A, 22A of the next carcass reinforcer 21, 22. Each turn-back loop 26 thus forms the end point of one carcass reinforcer 21, 22 and the starting point of the immediately following carcass reinforcer 21, 22, and therefore covers a circumferential portion about the central axis X10 which corresponds to the desired repeat pitch K1, K2.

The pressing members 33 are thus advantageously arranged so as to help form each turn-back loop 26 at the end of laying of the carcass reinforcer 21, 22 that immediately precedes said turn-back loop 26 and then to temporarily maintain said turn-back loop 26 during the laying of the carcass reinforcer 21, 22 that immediately follows said turn-back loop 26.

Particularly preferably, the step (b) of laying carcass reinforcers comprises a first sub-step (b1) of laying a first set of carcass reinforcers 21, during which a first plurality of carcass reinforcers 21 referred to as “first carcass reinforcers” 21, which are distributed angularly about the central axis X10 with a first predefined repeat pitch K1, are laid successively on the core 10, as can be seen in FIGS. 4, 5 and 6, by means of a laying head 20 which is configured in a first configuration which confers on it a first laying trajectory T1 contained in a first laying plane P1 which is parallel to the central axis X10 and at a distance, in this case at a first offset distance d1, from the central axis X10 such that the first laying trajectory T1 follows, next to the crown zone 12 of the core 10, a radial plane PR1 containing the central axis X10 while, in orthogonal projection in the reference plane P0 normal to the central axis X10, this same first laying trajectory T1 forms, in the first and second lateral zones 13, 14 of the core, a first non-zero inclination angle A1 with respect to said radial plane PR1 containing the central axis. Then, the step (b) includes a second sub-step b2 of laying a second set of carcass reinforcers 22, during which a second plurality of carcass reinforcers 22, referred to as “second carcass reinforcers” (22), which are distributed angularly about the central axis X10 with a second predefined repeat pitch K2, preferably equal to the first repeat pitch K1, are laid successively on the core 10, on top of the first set of carcass reinforcers 21, as can be seen in particular in FIG. 7, by means of a laying head 20 which is configured in a second configuration which confers on it a second laying trajectory T2 contained in a second laying plane P2 which is parallel to the central axis X10 and at a distance from the central axis X10, in this case at a second offset distance d2, such that the second laying trajectory T2 follows, next to the crown zone 12 of the core 10, a radial plane PR2 containing the central axis X10 while, in orthogonal projection in the reference plane P0 normal to the central axis X10, this same second laying trajectory T2 forms, in the first and second lateral zones 13, 14 of the core, a second inclination angle A2, which is not zero and of opposite sign to the first inclination angle A1, with respect to said radial plane PR2 containing the central axis X10, in order that the first carcass reinforcers 21 and the second carcass reinforcers 22 are interlaced in the first lateral zone 13 and in the second lateral zone 14, and therefore, ultimately, in the sidewalls 6, 7 of the tire 1, while said first carcass reinforcers 21 and second carcass reinforcers 22 extend parallel to one another, on radial planes, in the crown zone 12, and therefore, ultimately, in the crown 2 of the tire 1.

As can be seen in FIG. 3, the first set of carcass reinforcers 21 are advantageously embedded in a first layer of encapsulating rubber in order to form a first carcass ply 23, while the second set of carcass reinforcers 22, which are superposed on the first carcass ply 23, are embedded in a second layer of encapsulating rubber in order to form a second carcass ply 24. A so-called “carcass bi-ply” architecture is thus obtained, within which the second carcass ply 24 is superposed on the first carcass ply 23.

Advantageously, the intersecting disposition of the first carcass reinforcers 21 with the second carcass reinforcers 22 makes it possible to obtain crossed wiring of the crown 2 with respect to each of the first and second beads 4, 5 and to form a particularly robust and stiff diamond-shaped reinforcement in the sidewalls 6, 7 of the tire 1.

Preferably, as was described above, the first set of carcass reinforcers 21 are formed by a continuous thread shaped with as many juxtaposed bows as said first set has first carcass reinforcers 21, said bows each being contained in a laying plane oriented at the first inclination angle A1 and being linked together by turn-back loops 26 situated at the beads 4, 5, at the ends of said bows.

Similarly, the second set of carcass reinforcers 22 are formed by a continuous thread shaped with as many juxtaposed bows as said second set has second carcass reinforcers 22, said bows each being contained in a laying plane oriented at the second inclination angle A2 and being linked together by turn-back loops 26 situated at the beads 4, 5, at the ends of said bows.

Of course, after the carcass reinforcement according to the present disclosure has been produced, the method could involve, in a manner known per se, fitting in the crown zone 12 a first crown ply 35 having a plurality of reinforcing threads which are arranged parallel to one another and which form a non-zero and non-right angle with the circumferential direction L10, so as to intersect the crown portions of the carcass reinforcers 21, 22 lying in the radial planes. The carcass reinforcement further includes a second crown ply 36 having a plurality of reinforcing threads which are arranged parallel to one another and which form a non-zero and non-right angle with the circumferential direction L10, so as to intersect both the crown portions of the carcass reinforcers 21, 22 lying in the radial planes and the reinforcing threads of the first crown ply 35, in order thereby to form triangular reinforcement meshes in the crown 2 of the tire 1. Preferably, the carcass reinforcement further includes a reinforcing belt 37 which circles the crown plies 35, 36 with a reinforcer oriented substantially along the circumferential direction L10. The reinforcer is able to be formed by a continuous band wrapped in helical turns, preferably partially overlapping one another, about the central axis X10. The tire further includes a tread 3.

It is conceivable to use a plurality of laying heads 20 within the installation 100, and in particular a first laying head 20 which would be arranged in the first configuration and would be dedicated (exclusively) to laying the first set of carcass reinforcers 21, at the first inclination angle A1, and a second laying head 20 which would be arranged in the second configuration and would be dedicated (exclusively) to laying the second set of carcass reinforcers 22, at the second inclination angle A2.

However, preferably, the same laying head 20 will be used for laying the first set of carcass reinforcers 21 and then for laying the second set of carcass reinforcers 22, by passing said laying head 20 successively from its first configuration (FIGS. 4 to 6), used for the first sub-step (b1) of laying the first set of carcass reinforcers 21, to its second configuration (FIG. 7), used for the second sub-step (b2) of laying the second set of carcass reinforcers 22.

In other words, in order to pass from one set of carcass reinforcers to the other, the laying head 20 will be reconfigured so as to modify the orientation of the laying plane P1, P2, so as to change this orientation from the first inclination angle Al to the second inclination angle A2.

Preferably, the step (b) of laying carcass reinforcers includes an adjusting sub-step (b0) during which an adjustment is carried out which makes it possible to place the laying head 20 in the configuration corresponding to the desired inclination angle A1, A2.

More preferably, if it takes place, the step (b) of laying carcass reinforcers may include an adjusting sub-step (b0) during which an adjustment is carried out which makes it possible to pass one and the same laying head 20 from the first configuration to the second configuration, that is to say an adjusting operation which makes it possible to switch between the first configuration and the second configuration, or vice versa, in order to pass from laying the first set of carcass reinforcers 21 to laying the second set of carcass reinforcers 22, or vice versa.

In either case, said adjustment may comprise a translational offset component T30, according to which the laying head 20, in this case more particularly the laying body 30, is moved in rectilinear translation along a direction orthogonal to the central axis X10. Alternately, the adjustment may include a pitch offset component R_X30, according to which the laying head 20, in this case more particularly the laying body 30, is pivoted about an auxiliary pitch axis X30 which is parallel to the central axis X10 of the core and at a distance from said central axis X10. The adjustment could alternatively include a combination of the translation offset component T30 and the pitch offset component R_X30.

Thus, by means of a simple, compact, rigid and therefore precise structure, the orientation angle A1, A2 of the laying plane P1, P2 could be adapted on a case by case basis, by modifying its offset distance d1 and d2 and/or its offset direction with respect to the central axis X10.

The use of a pitch rotational adjustment component R_X30 advantageously makes it possible to increase the offset, in a limited space, by avoiding the need to effect a translational reversal of the laying body 30 with respect to the frame of the installation 100 over too long a distance, and therefore by limiting the risks of mechanical interference between the laying head 20, and more specifically the laying body 30, and the rest of the structure of the installation 100.

By way of indication, the inclination angle A1, A2 of the laying trajectory T1, T2 is preferably, in terms of absolute value, between 10 degrees and 30 degrees.

More particularly, when two sets of carcass reinforcers 21, 22 with different inclinations are laid, each of the first inclination angle A1 and second inclination angle A2 is preferably, in terms of absolute value, between 10 degrees and 30 degrees.

According to one possible embodiment, the second inclination angle A2 may be equal, in terms of absolute value, to the first inclination angle A1, but of opposite sign.

According to another possible embodiment, the first inclination angle A1 and the second inclination angle A2 may not only be of opposite sign but may also have different absolute values. For example, the following may be chosen: A1=+10 degrees and A2=−30 degrees.

Of course, the present disclosure also relates to a tire 1 obtained by a method according to the present disclosure.

More particularly, the present disclosure relates to such a tire 1 which has a carcass which comprises first carcass reinforcers 21 and second carcass reinforcers 22 which are interlaced in the sidewalls 6, 7 of the tire 1 and oriented parallel to one another, on radial planes, in the crown 2 of the tire 1.

The present disclosure also relates to an installation 100 for manufacturing a tire 1. The installation 100 includes a core 10 which has a toroidal receiving surface 11 which is centred on a central axis X10 and which comprises a crown zone 12 intended to receive components of the crown 2 of the tire 1, and, axially on either side of said crown zone 12, a first lateral zone 13 intended to receive components of a first sidewall 6 and of a first bead 4 of the tire, and a second lateral zone 14 axially opposite the first lateral zone 13 and intended to receive components of a second sidewall 7 and of a second bead 5 of the tire. The installation also includes at least one laying head 20 designed to be able to successively lay, on the receiving surface 11 of the core, a plurality of reinforcers referred to as “carcass reinforcers” 21, 22 which each extend from a starting position 21A, 22A, situated in the first lateral zone 13, to an end position 21B, 22B, situated in the second lateral zone 14, passing through the crown zone 12, the laying head 20 is mounted so as to be able to tilt about an axis referred to as the “roll axis” Y20 which is orthogonal to the central axis X10.

The roll axis Y20 is more preferably contained in a plane referred to as the “median plane” which is normal to the central axis X10 and which is situated mid-way across the axial width W11 of the receiving surface 11, and which preferably corresponds to the equatorial plane P_EQ of the tire 1 manufactured on the core 10.

The core 10 is mounted on a support 38 so as to be able to rotate about its central axis X10.

The central axis X10 is preferably horizontal.

According to the present disclosure, the installation 100 comprises adjusting members 40, 41 designed to place the laying head 20 in at least one configuration in which the roll axis Y20 is oriented such that the trajectory, referred to as the “laying trajectory” T1, T2, that said laying head 20 describes, by tilting about the roll axis Y20, in order to connect the starting position 21A, 22A of each carcass reinforcer 21, 22 to the end position 21B, 22B of said carcass reinforcer, is contained in a plane referred to as the “laying plane” P1, P2 which is parallel to the central axis X10 and at a distance from the central axis X10, such that the laying trajectory T1, T2 follows, next to the crown zone 12 of the core, a radial plane PR1, PR2 containing the central axis while, in orthogonal projection in a reference plane P0 normal to the central axis X10, this same laying trajectory T1, T2 has, in the first and second lateral zones 13, 14 of the core 10, a non-zero inclination angle A1, A2 with respect to said radial plane PR1, PR2 containing the central axis.

Preferably, the adjusting members 40, 41 are designed to be able to alternately pass the laying head 20 from a first configuration (FIGS. 4, 5 and 6), to which a first inclination angle A1 of the laying plane P1 corresponds, and which allows the laying head 20 to lay a first set of carcass reinforcers 21 which are oriented at said first inclination angle A1 in the first and second lateral zones 13, 14 of the core 10 and which are oriented on radial planes PR1 in the crown zone 12 to a second configuration (FIG. 7), to which a second inclination angle A2 of the laying plane P2, of opposite sign to the first inclination angle A1, corresponds, and which allows the laying head 20 to lay, on top of the first set of carcass reinforcers 21, a second set of carcass reinforcers 22 which are oriented at the second inclination angle A2 in the first and second lateral zones 13, 14 of the core so as to intersect the carcass reinforcers 21 of the first set in said first and second lateral zones 13, 14 of the core 10, and which are oriented on radial planes PR2, parallel to the carcass reinforcers 21 of the first set, in the crown zone 12 of the core 10, as is illustrated in particular in FIG. 2.

Preferably, as can be seen in FIGS. 4, 6 and 7, the adjusting members 40, 41 comprise a translational adjustment carriage 40 which makes it possible to move the laying head 20, in this case more particularly the laying body 30, in rectilinear translation T30 with respect to the core 10, and more generally with respect to the support 38, along a direction orthogonal to the central axis X10, in this case, for example, along a vertical direction embodied by a vertical mast 42 provided with one or more rails guiding said carriage 40 and/or a cradle 41 which makes it possible to pitch tilt R_X30 the laying head 20, in this case more particularly the laying body 30, about an auxiliary pitch axis X30 which is parallel to the central axis X10 and at a distance from said central axis X10.

Preferably, the cradle 41 is on board the carriage 40.

Advantageously, the adjusting members 40, 41 make it possible to reconfigure the laying head 20, and more particularly the position and the orientation in space of the laying body 30 and therefore of the laying head 20, with respect to the support 38 and therefore with respect to the central axis X10 of the core 10, depending on the desired inclination angle A1, A2 for laying the carcass reinforcers 21, 22 in question.

Preferably, the installation 100 comprises a control unit for automatically configuring the laying head 20 depending, in particular, on an inclination angle A1, A2 setpoint. To this end, the control unit will preferably make it possible to control motors, preferably electric motors, which actuate the adjusting members 40, 41. The control unit could in particular comprise a selector for controlling switching from the first configuration to the second configuration and, vice versa, switching from the second configuration to the first configuration.

Furthermore, the installation 100 preferably also comprises positioning members 43, 44 for positioning the laying head 20 in the desired radial position and in the desired axial position with respect to the central axis X10 of the core 10.

These positioning members 43, 44 could be formed by at least one horizontal translation table 43, preferably oriented orthogonally to the central axis X10, or, alternatively, by two crossed horizontal translation tables 43, 44, one oriented parallel to the central axis X10 to ensure the axial position and the other oriented orthogonally to the central axis X10 to ensure the radial position. The vertical mast 42 is preferably on board said translation table or, respectively, on board said crossed translation tables.

These positioning members 43, 44 will preferably be motor-driven, preferably by electric motors, and controlled by the abovementioned control unit.

Furthermore, the installation 100 preferably comprises a control unit (where appropriate the same control unit as the one already mentioned above) provided with a sequencer which is designed to carry out automatically, and to repeat as many times as necessary in order to cover a complete rotation of the core 10 about the central axis X10, a sequence referred to as an “elementary sequence” which comprises a positioning phase during which the sequencer positions the laying head 20 next to a starting position 21A, 22A of a carcass reinforcer 21, 22 to be laid, in a predefined angular sector of the core 10 about the central axis X10 then a laying phase during which the sequencer brings about the roll tilting R_Y20 of the laying head 20 about the roll axis Y20, while the core 10 is rotationally fixed about its central axis X10, so as to lay a carcass reinforcer 21, 22 in the angular sector in question along the laying trajectory T1, T2 contained in the chosen laying plane P1, P2, parallel to the central axis X10 and at a distance from said central axis X10 then an incrementing phase, during which the sequencer increments the angular position of the core 10 about its central axis X10 by an increment value which is defined on the basis of, and preferably so as to be equal to, a chosen repeat pitch K1, K2 with which the carcass reinforcers 21, 22 are intended to be distributed about the central axis X10, and then the sequencer immobilizes the core 10 in said angular position, such that the core 10 has, next to the laying head, a new angular sector in which it is possible to lay, in the next elementary sequence, another carcass reinforcer 21, 22 while retaining the chosen laying plane P1, P2.

Advantageously, the adjusting members 40, 41 make it possible to retain a fixed setting of the laying body 30, and therefore of the configuration of the laying head 20, with respect to the frame of the installation and to the central axis of the core X10, throughout the laying of a single set of carcass reinforcers 21, 22, while the core 10 turns incrementally, between each instance of laying a new carcass reinforcer 21, 22 by tilting the rocker arm 32.

Of course, the present disclosure is in no way limited just to the embodiment variants described above, and a person skilled in the art could in particular isolate or freely combine any of the abovementioned features, or replace them with equivalent features.

In particular, the tire 1 obtained according to the present disclosure may be combined with other known technologies such as the use of nails to improve the grip of the tire on ice or snow, the incorporation into the cavity of the tire of a foam intended to attenuate noise, the addition to the cavity of the tire of a self-sealing substance capable of automatically repairing punctures, the use in the tread of regenerating tread patterns which expose new voids, initially hidden, as wear progresses and therefore during the loss of thickness of the tread 3, etc.

1. A method for manufacturing a tire, comprising:
a preparation step (a) during which a core is prepared which has a toroidal receiving surface which is centered on a central axis and which comprises a crown zone intended to receive components of the crown of the tire, and, axially on either side of said crown zone, a first lateral zone intended to receive components of a first sidewall and of a first bead of the tire, and a second lateral zone intended to receive components of a second sidewall and of a second bead of the tire,
then a step (b) of laying carcass reinforcers, during which a plurality of carcass reinforcers which each extend from a starting position, situated in one of the first and second lateral zones to an end position, situated in the other of the first and second lateral zones, passing through the crown zone, are laid on the receiving surface of the core, by means of a laying head,
during the step (b) of laying carcass reinforcers, the laying head is configured with respect to the core so as to describe, each time a carcass reinforcer is laid, a laying trajectory which connects the starting position of the carcass reinforcer in question to the end position of the reinforcer in question and which is contained in a laying plane which is parallel to the central axis and at a distance from the central axis such that the laying trajectory follows, next to the crown zone of the core, a radial plane containing the central axis while, in orthogonal projection in a reference plane normal to the central axis, this same laying trajectory and more generally the laying plane, form, in the first and second lateral zones of the core, a non-zero inclination angle with respect to said radial plane containing the central axis.

2. The method according to claim 1, wherein the step (b) of laying carcass reinforcers comprises:
a first sub-step (b1) of laying a first set of carcass reinforcers, during which a plurality of first carcass reinforcers, which are distributed angularly about the central axis with a first predefined repeat pitch, are laid successively on the core by means of a laying head which is configured in a first configuration which confers on it a first laying trajectory contained in a first laying plane which is parallel to the central axis and at a distance from the central axis such that the first laying trajectory follows, next to the crown zone of the core, a radial plane containing the central axis while, in orthogonal projection in the reference plane normal to the central axis, this same first laying trajectory forms, in the first and second lateral zones of the core, a first non-zero inclination angle with respect to said radial plane containing the central axis,
then a second sub-step (b2) of laying a second set of carcass reinforcers, during which a plurality of second carcass reinforcers, which are distributed angularly about the central axis with a second predefined repeat pitch, are laid successively on the core, on top of the first set of carcass reinforcers, by means of a laying head which is configured in a second configuration which confers on it a second laying trajectory contained in a second laying plane which is parallel to the central axis and at a distance from the central axis such that the second laying trajectory follows, next to the crown zone of the core, a radial plane containing the central axis while, in orthogonal projection in the reference plane normal to the central axis, this same second laying trajectory forms, in the first and second lateral zones of the core, a second inclination angle, which is not zero and of opposite sign to the first inclination angle, with respect to said radial plane containing the central axis, in order that the first carcass reinforcers and the second carcass reinforcers are interlaced in the first lateral zone and in the second lateral zone, while they extend parallel to one another, on radial planes, in the crown zone.

3. The method according to claim 2, wherein the same laying head is used for laying the first set of carcass reinforcers and then for laying the second set of carcass reinforcers, by passing said laying head successively from its first configuration, used for the first sub-step (b1) of laying the first set of carcass reinforcers, to its second configuration, used for the second sub-step (b2) of laying the second set of carcass reinforcers.

4. The method according to one of claim 1, wherein the inclination angle of the laying trajectory, where appropriate each of the first inclination angle and the second inclination angle, is, in terms of absolute value, between 10 degrees and 30 degrees.

5. The method according to claim 1, wherein the core is mounted so as to be able to rotate about its central axis, in that the laying head, in order to be able to execute the laying trajectory, is mounted so as to be able to tilt about a roll axis which is orthogonal to the central axis, and wherein, each time a new carcass reinforcer is laid, an elementary sequence is carried out, the elementary sequence comprising:
a positioning phase during which the laying head is positioned next to the starting position of the carcass reinforcer to be laid, in a predefined angular sector of the core about the central axis,
then a laying phase during which the roll tilting of the laying head about the roll axis is brought about, while the core is rotationally fixed about its central axis, so as to lay the carcass reinforcer in the angular sector in question along the laying trajectory contained in the chosen laying plane, parallel to the central axis and at a distance from said central axis,
then an incrementing phase, during which the rotation of the core is triggered so as to increment the angular position of the core about its central axis by an increment value which is defined on the basis of, and preferably so as to be equal to, a chosen repeat pitch with which the carcass reinforcers are intended to be distributed about the central axis, and then the core is immobilized in said angular position, such that the core has, next to the laying head, a new angular sector in which it is possible to lay, in a next elementary sequence, another carcass reinforcer while retaining the chosen laying plane.

6. The method according to claim 1, wherein the step (b) of laying carcass reinforcers includes an adjusting sub-step (b0) during which an adjustment is carried out which makes it possible to place the laying head in the configuration corresponding to the desired inclination angle, and, where necessary, to pass one and the same laying head from the first configuration to the second configuration, said adjustment including:
a translational offset component, according to which the laying head is moved in rectilinear translation along a direction orthogonal to the central axis, or
a pitch offset component, according to which the laying head is pivoted about an auxiliary pitch axis which is parallel to the central axis of the core and at a distance from said central axis, or
a combination of said translation offset component and said pitch offset component.

7. The method according to claim 1, wherein each carcass reinforcer is formed by a thread, or more preferably by a set of a plurality of threads that are interwoven to form a cord, said thread, or said threads, being made from a textile material.

8. A tire obtained by a method according to claim 1, the tire having a carcass which comprises first carcass reinforcers and second carcass reinforcers which are interlaced in the sidewalls of said tire and oriented parallel to one another, on radial planes, in the crown of said tire.

9. An installation for manufacturing a tire, comprising:
a core which has a toroidal receiving surface which is centred on a central axis and which comprises a crown zone intended to receive components of the crown of the tyre, and, axially on either side of said crown zone, a first lateral zone intended to receive components of a first sidewall and of a first bead of the tire, and a second lateral zone axially opposite the first lateral zone and intended to receive components of a second sidewall and of a second bead of the,
at least one laying head designed to be able to successively lay, on the receiving surface of the core, a plurality of carcass reinforcers which each extend from a starting position, situated in the first lateral zone, to an end position situated in the second lateral zone, passing through the crown zone, said laying head being mounted so as to be able to tilt about a roll axis which is orthogonal to the central axis, said installation comprising adjusting members designed to place the laying head in at least one configuration in which the roll axis is oriented such that a laying trajectory, that said laying head describes, by tilting about the roll axis, in order to connect the starting position of each carcass reinforcer to the end position of said carcass reinforcer, is contained in a laying plane which is parallel to the central axis and at a distance from the central axis, such that the laying trajectory follows, next to the crown zone of the core, a radial plane containing the central axis while, in orthogonal projection in a reference plane normal to the central axis, this same laying trajectory has, in the first and second lateral zones of the core, a non-zero inclination angle with respect to said radial plane containing the central axis.

10. The installation according to claim 9, further comprising a control unit provided with a sequencer which is designed to carry out automatically, and to repeat as many times as necessary in order to cover a complete rotation of the core about the central axis, an elementary sequence which comprises:
a positioning phase during which the sequencer positions the laying head next to a starting position of a carcass reinforcer to be laid, in a predefined angular sector of the core about the central axis,
then a laying phase during which the sequencer brings about the roll tilting of the laying head about the roll axis, while the core is rotationally fixed about its central axis, so as to lay a carcass reinforcer in the angular sector in question along the laying trajectory contained in the chosen laying plane, parallel to the central axis and at a distance from said central axis,
then an incrementing phase, during which the sequencer increments the angular position of the core about its central axis by an increment value which is defined on the basis of a chosen repeat pitch with which the carcass reinforcers are intended to be distributed about the central axis, and then the sequencer immobilizes the core in said angular position, such that the core has, next to the laying head, a new angular sector in which it is possible to lay, in the next elementary sequence, another carcass reinforcer while retaining the chosen laying plane.

11. The installation according to claim 9, wherein the adjusting members comprise a translational adjustment carriage which makes it possible to move the laying head in rectilinear translation with respect to the core, along a direction orthogonal to the central axis, and/or a cradle which makes it possible to pitch tilt the laying head about an auxiliary pitch axis which is parallel to the central axis and at a distance from said central axis.

12. The installation according to claim 9, wherein the adjusting members are designed to be able to alternately pass the laying head from a first configuration, to which a first inclination angle of the laying plane corresponds, and which allows the laying head to lay a first set of carcass reinforcers which are oriented at said first inclination angle in the first and second lateral zones of the core and which are oriented on radial planes in the crown zone, to a second configuration, to which a second inclination angle of the laying plane, of opposite sign to the first inclination angle, corresponds, and which allows the laying head to lay, on top of the first set of carcass reinforcers, a second set of carcass reinforcers which are oriented at the second inclination angle in the first and second lateral zones of the core so as to intersect the carcass reinforcers of the first set in said first and second lateral zones of the core, and which are oriented on radial planes, parallel to the carcass reinforcers of the first set, in the crown zone of the core.

13. The method according to claim 2, wherein the second repeat pitch is equal to the first repeat pitch.
